(19) United States
(12) Patent Application Publication
(10) Pub. No.: US 2025/0062648 A1
(43) Pub. Date: Feb. 20, 2025

(54) ROTOR AND ROTATING ELECTRICAL MACHINE

(71) Applicant: NIDEC CORPORATION, Kyoto (JP)

(72) Inventors: Yabo HU, Kyoto (JP); Tomoya UEDA, Kyoto (JP)

(21) Appl. No.: 18/697,000

(22) PCT Filed: Jun. 17, 2022
(86) PCT No.: PCT/JP2022/024254

§ 371 Date: Sep. 20, 2024

(30) Foreign Application Priority Data
Sep. 30, 2021 (JP) 2021-161222

(51) Int. Cl. H02K 1/2783

(52) U.S. Cl. CPC H02K 1/2783

(57) ABSTRACT

A rotor according to one aspect of the present invention is a rotor that is provided to a rotating electrical machine, opposes a stator, and rotates about a central axis line. The rotor includes: a plurality of magnetic pole parts lined along a circumferential direction centered on the central axis line; and a rotor core that supports the magnetic pole parts from one side of a radial direction. The magnetic pole part includes a main magnet whose magnetization direction is the radial direction; and secondary magnets whose magnetization directions are directions tilted in a circumferential direction with respect to the radial direction, the secondary magnets being disposed symmetrically with each other on an outer side of the main magnet in the circumferential direction. At least some of side faces of the secondary magnet extending in the axial direction are flat faces that are parallel or orthogonal to the magnetization direction.

### FIELD

The present invention relates to a rotor and a rotating electrical machine.

### BACKGROUND

There are motors known to increase the drive torque by arranging magnets of a rotor in the Halbach array (for example, Patent Literature 1).

### CITATION LIST

### Patent Literature

Patent Literature 1: Japanese Patent No. 5714189

### SUMMARY

### Technical Problem

The magnets in the Halbach array include main magnets whose magnetization direction is the radial direction and secondary magnets whose magnetization direction is the circumferential direction. The secondary magnet forms a circumferential magnetic path between the main magnets. Therefore, by bringing the secondary magnets into contact with the main magnets, the magnetic resistance between the magnets is reduced and high output of the rotating electrical machine can be achieved. However, it is difficult to arrange the main magnets and the secondary magnets without gaps since the main magnets and secondary magnets each have dimensional tolerance.

In view of the aforementioned circumstances, it is an object of the present invention to provide a rotor and a rotating electrical machine capable of achieving even higher output with a rotor having magnets arranged in the Halbach array.

### Solution to Problem

A rotor according to one aspect of the present invention is a rotor that is provided to a rotating electrical machine, opposes a stator, and rotates about a central axis line. The rotor includes: a plurality of magnetic pole parts lined along a circumferential direction centered on the central axis line; and a rotor core that supports the magnetic pole parts from one side of a radial direction. The magnetic pole part includes: a main magnet whose magnetization direction is the radial direction; and secondary magnets whose magnetization directions are directions tilted in a circumferential direction with respect to the radial direction, the secondary magnets being disposed symmetrically with each other on an outer side of the main magnet in the circumferential direction. At least some of side faces of the secondary magnet extending in the axial direction are flat faces that are parallel or orthogonal to the magnetization direction.

### Advantageous Effects of Invention

According to one aspect of the present invention, it is possible to provide the rotor and the rotating electrical machine capable of achieving even higher output with the rotor having the magnets arranged in the Halbach array.

### BRIEF DESCRIPTION OF DRAWINGS

FIG. 1 is a cross-sectional schematic diagram of a rotating electrical machine according to an embodiment in a cross section along a central axis line.

FIG. 2 is a plan view of a rotor according to an embodiment.

FIG. 3 is a plan view of a rotor according to a modification example.

### DESCRIPTION OF EMBODIMENTS

In the following description, an axial direction of a central axis line J, that is, the direction parallel to the top-and-bottom direction, is simply referred to as an “axial direction”, a radial direction centered on the central axis line J is simply referred to as a “radial direction”, and a circumferential direction centered on the central axis line J is simply referred to as a “circumferential” direction. In the present embodiment, an upper side (+Z) corresponds to one side in the axial direction, and a lower side (−Z) corresponds to the other side in the axial direction. Note that the top-and-bottom direction and the upper side and lower side are simply the terms used to describe the relative positional relationship of each part, and the actual placement relationship and the like may be a placement relationship and the like other than those indicated by those terms.

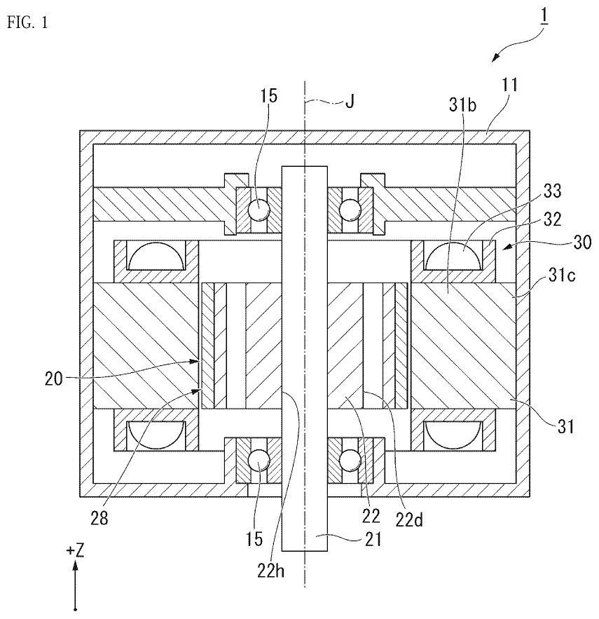

FIG. 1 is a cross-sectional schematic diagram of a rotating electrical machine 1 in a cross section along the central axis line J.

The rotating electrical machine 1 according to the present embodiment includes a rotor 20, a stator 30, a plurality of bearings 15, and a housing 11 that houses those. The bearings 15 support a shaft 21 of the rotor 20 in a rotatable manner. The bearings 15 are held in the housing 11.

The rotating electrical machine 1 according to the present embodiment is an inner rotor-type rotating electrical machine in which the rotor 20 is disposed on the inner side of the stator 30 in the radial direction. Furthermore, in the embodiment described hereinafter, it is assumed that the inner side in the radial direction is one side of the radial direction and the outer side in the radial direction is the other side of the radial direction. However, the rotating electrical machine may also be an outer rotor-type in which the rotor is disposed on the outer side of the stator in the radial direction. In that case, one side and the other side of the radial direction are inverted in each component of the rotor.

The stator 30 forms an annular shape centered on the center axis line J. The rotor 20 is disposed on the inner side of the stator 30 in the radial direction. The stator 30 opposes the rotor 20 in the radial direction.

The stator 30 includes a stator core 31, an insulator 32, and a plurality of coils 33. The stator core 31 is configured with a plurality of magnetic members stacked along the axial direction.

The stator core 31 includes a substantially annular core back 31c and a plurality of teeth 31b. In the present embodiment, the core back 31c forms an annular shape centered on the central axis line J. The teeth 31b extend to the inner side in the radial direction from the inner side face of the core back 31c in the radial direction. The outer peripheral face of the core back 31c is fixed to the inner peripheral face of the peripheral wall part of the housing 11. The teeth 31b are disposed on the inner side face of the core back 31c in the radial direction with a space provided from each other in the circumferential direction. In the present embodiment, the teeth 31b are arranged at equal intervals in the circumferential direction.

The insulator 32 is mounted to the stator core 31. The insulator 32 has a part that covers the teeth 31b. The material of the insulator 32 is an insulating material such as resin, for example.

The coil 33 is attached to the stator core 31. The coils 33 are mounted to the stator core 31 via the insulator 32. The coils 33 are configured with conductors wound around each of the teeth 31b via the insulator 32. The rotor 20 is provided in the rotating electrical machine 1 and opposes the stator 30. The rotor 20 rotates about the central axis line J. The rotor 20 includes the shaft 21, a rotor core 22, and a plurality (eight in the present embodiment) of magnetic pole parts 28 lined along the circumferential direction on the outer peripheral face of the rotor core 22. Note that the rotor 20 may further include a cylindrical cover member that surrounds the whole body from the outer side in the radial direction.

The shaft 21 forms a cylindrical shape that extends in the axial direction with respect to the central axis line J. The shaft 21 is supported by a pair of bearings 15 in a rotatable manner.

The rotor core 22 forms a columnar shape that extends in the axial direction along the central axis line J. The rotor core 22 forms a substantially polygonal shape when viewed from the axial direction. The rotor core 22 is formed with a ferromagnetic material. The rotor core 22 according to the present embodiment is configured with a plurality of magnetic members stacked along the axial direction.

The rotor core 22 is provided with a central hole 22h and a lightening hole part 22d opened through in the axial direction. The central hole 22h is located in the center of the rotor core 22 when viewed from the axial direction. The shaft 21 is inserted and fixed to the central hole 22h. The lightening hole part 22d is provided to lighten the rotor core 22 by removing a portion from the rotor core 22.

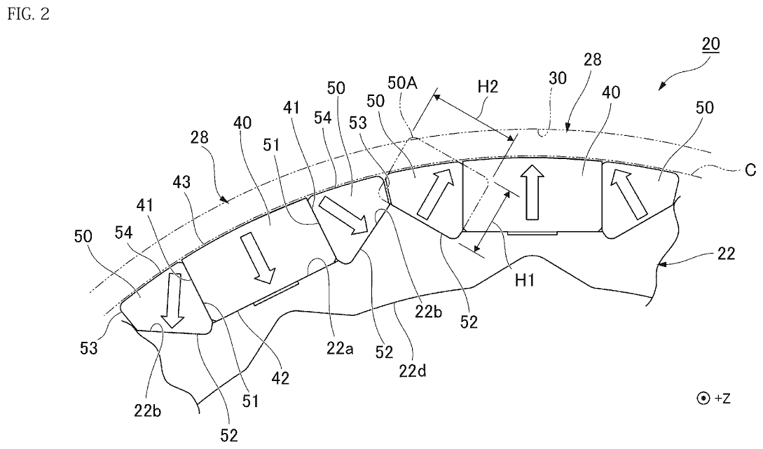

FIG. 2 is a plan view illustrating part of the rotor 20.

The rotor 20 according to the present embodiment is a surface permanent magnet (SPM) rotor. On the outer peripheral face of the rotor core 22 facing the outer side in the radial direction, main magnets 40 and secondary magnets 50 configuring the magnetic pole parts 28 are bonded and fixed. Thereby, the rotor core 22 supports the magnetic pole parts 28 from the inner side in the radial direction (one side of the radial direction).

The rotor 20 includes a plurality of (16 in the present embodiment) magnetic pole parts 28. The magnetic pole parts 28 are lined along the circumferential direction centered on the central axis line J. The magnetic pole parts 28 are disposed at equal intervals along the circumferential direction. The magnetic flux directions of the magnetic pole parts 28 adjacent to each other in the circumferential direction are inverted from each other in the radial direction. In other words, as for the magnetic pole parts 28 lined in the circumferential direction, the one with the N-pole facing the outer side in the radial direction and the one with the S-pole facing the outer side are disposed alternately along the circumferential direction.

One magnetic pole part 28 includes one main magnet 40 and two secondary magnets 50. The secondary magnets 50 are disposed symmetrically with each other on the outer side of the main magnet 40 in the circumferential direction. Therefore, at the boundary between the magnetic pole parts 28 adjacent to each other in the circumferential direction, the secondary magnets 50 of different magnetic pole parts 28 are disposed adjacent to each other. In the rotor 20, two secondary magnets 50 are disposed between a pair of main magnets 40.

The main magnet 40 and the secondary magnet 50 each have a uniform cross section and extend in a columnar shape along the axial direction of the central axis line J. The top faces of the main magnet 40 and the secondary magnet 50 form a substantially same plane. Similarly, the bottom faces of the main magnet 40 and the secondary magnet 50 form a substantially same plane.

The magnetization direction of the main magnet 40 is the radial direction. On the other hand, the magnetization direction of the secondary magnet 50 is a direction that is tilted in the circumferential direction with respect to the radial direction. As described above, in one magnetic pole part 28, a pair of secondary magnets 50 are disposed symmetrically with each other on the outer side in the circumferential direction with respect to the main magnet 40. Therefore, the magnetization directions of the pair of secondary magnets 50 are symmetrical with each other with respect to the main magnet 40.

In FIG. 2, arrows illustrated in the main magnets 40 and the secondary magnets 50 in the drawings represent the magnetization directions of the respective magnets. As illustrated in FIG. 2, the main magnets 40 of the magnetic pole parts 28 adjacent to each other in the circumferential direction have different magnetization directions from each other on the inner side and outer side of the radial direction. In other words, the magnetization directions of the main magnets 40 in the magnetic pole parts 28 adjacent to each other in the circumferential direction are inverted from each other. The magnetization directions of the secondary magnets 50 located on the outer side in the circumferential direction of the main magnet 40 whose magnetization direction is toward the outer side in the radial direction are the directions that head toward the outer side in the radial direction as approaching the main magnet 40. The magnetization directions of the secondary magnets 50 located on the outer side in the circumferential direction of the main magnet 40 whose magnetization direction is toward the inner side in the radial direction are the directions that head toward the inner side in the radial direction as being away from the main magnet 40. As described, the main magnets 40 and the secondary magnets 50 configuring each of the magnetic pole parts 28 are lined in the Halbach array.

In magnetic poles with the magnets arranged in an array generally referred to as the Halbach array, the magnetization direction of the secondary magnets is defined to be in the circumferential direction. In contrast, in the magnetic pole parts 28 of the present embodiment, the magnetization direction of the secondary magnets 50 is tilted in the radial direction with respect to the perfect circumferential direction. As described, by tilting the magnetization direction of the secondary magnets in the radial direction, the magnetic field formed from the outer peripheral face of the main magnet 40 to the outer side in the radial direction can be strengthened compared to the case where the magnetization direction is the perfect circumferential direction, thereby achieving higher output of the rotating electrical machine 1.

The main magnet 40 is in a substantially rectangular shape when viewed from the axial direction. The main magnet 40 has four side faces 41, 41, 42, and 43 extending along the axial direction. In other words, the main magnet 40 has a pair of main magnet side faces 41 facing the circumferential direction, a main magnet supported face 42 facing the inner side in the radial direction (one side of the radial direction), and a main magnet opposing face 43 facing the outer side in the radial direction (the other side of the radial direction). Among the four side faces 41, 41, 42 and 43 of the main magnet 40, the pair of main magnet side faces 41 and the main magnet supported face 42 are flat faces.

The pair of main magnet side faces 41 face the opposite side from each other in the circumferential direction. That is, each of the main magnet side faces 41 faces the outer side in the circumferential direction with respect to the main magnet 40. The main magnet side faces 41 are flat faces extending along the radial direction. The pair of main magnet side faces 41 according to the present embodiment are parallel to each other. Thus, the main magnet side faces 41 are slightly tilted with respect to the radial direction. Note that the main magnet side faces 41 may be flat faces that are perfectly aligned with the radial direction.

The main magnet supported face 42 is a flat face orthogonal to the radial direction. The main magnet supported face 42 opposes and contacts the rotor core 22, thereby being supported. The rotor core 22 has a first support face 22a that supports the main magnet supported face 42. The main magnet supported face 42 is fixed to the first support face 22a by an adhesive, for example. Thereby, the main magnet 40 is fixed to the rotor core 22.

The main magnet opposing face 43 opposes the stator 30. The main magnet opposing face 43 is a gently curved face with a constant distance to the central axis line J. Therefore, the thickness dimension of the main magnet 40 along the radial direction is the largest in the center of the circumferential direction and decreases toward both sides of the circumferential direction. In the present embodiment, the main magnet opposing face 43 is an arc face with a constant radius of curvature.

As illustrated in FIG. 2, it is assumed herein that there is a virtual circle C connecting the outer circumferential edges of the main magnet opposing faces 43 of a plurality of main magnets 40. The virtual circle C is an imaginary circle centered on the central axis line J. The main magnet opposing face 43 is inscribed in the virtual circle C in the center in the circumferential direction.

While the virtual circle C is illustrated in FIG. 2 by being slightly separated from the main magnets 40 and the secondary magnets 50 for clarity, the magnets are actually inscribed.

The main magnet opposing face 43 according to the present embodiment is an arc face whose radius of curvature is smaller than the radius of the virtual circle C. Therefore, the magnetic flux density of the magnetic field formed from the main magnet opposing face 43 to the outer side in the radial direction can be increased in the center of the main magnet opposing face 43 in the circumferential direction. This allows the drive torque of the rotor 20 to be increased, thereby making it possible to achieve higher output of the rotating electrical machine 1.

The secondary magnet 50 is in a substantially rectangular shape when viewed from the axial direction. The secondary magnet 50 has four side faces 51, 52, 53, and 54 extending along the axial direction. That is, the secondary magnet 50 has a first side face 51, a second side face 52, a third side face 53, and a secondary magnet opposing face 54. The four side faces 51, 52, 53, and 54 of the secondary magnet 50 are all flat faces.

The first side face 51 is a flat face that extends along the radial direction and faces the circumferential direction. The first side face 51 opposes and contacts the main magnet side face 41 in the circumferential direction. That is, the secondary magnet 50 contacts the main magnet 40 at the first side face 51.

The second side face 52 is a flat face that faces the outer side in the radial direction and the inner side in the radial direction. The second side face 52 faces the opposite side of the first side face 51 in the circumferential direction. That is, the second side face 52 faces the outer side in the radial direction with respect to the main magnet 40. Furthermore, the second side face 52 faces the rotor core 22 side in the radial direction (that is, inner side in the radial direction). The second side face 52 is tilted toward the outer side in the radial direction (toward the other side of the radial direction) as going toward the outer side in the circumferential direction.

The second side face 52 opposes and contacts the rotor core 22, thereby being supported. The rotor core 22 has a second support face (support face) 22b that supports the second side face 52. The second side face 52 is fixed to the second support face 22b by an adhesive, for example. Thereby, the secondary magnet 50 is fixed to the rotor core 22.

The third side face 53 faces the opposite side of the first side face 51 in the circumferential direction. The third side face 53 extends along the radial direction. The third side face 53 is a face that is substantially parallel to the first side face 51.

The secondary magnet opposing face 54 faces the outer side in the radial direction (the other side of the radial direction). The secondary magnet opposing face 54 opposes the stator 30. The secondary magnet opposing face 54 is a flat face extending along a plane that is orthogonal to the radial direction.

The secondary magnet opposing face 54 is inscribed in the virtual circle C. In other words, in the present embodiment, the main magnet opposing face 43 and the secondary magnet opposing face 54 are inscribed in the common virtual circle C. This allows the dimension of the gap between the main magnet 40 and the stator 30 to be the same as the dimension of the gap between the secondary magnet 50 and the stator 30. Thereby, both the main magnet 40 and the secondary magnet 50 can be brought as close as possible to the stator 30 to achieve higher output of the rotating electrical machine 1.

In the present embodiment, the secondary magnet opposing face 54 is a flat face that is orthogonal to the radial direction. With the secondary magnet opposing face 54 being a flat face, the secondary magnet opposing face 54 can be formed by surface grinding in the manufacturing process of the secondary magnet 50, which makes it easier to improve the dimensional accuracy of the secondary magnet opposing face 54. Furthermore, by forming the secondary magnet opposing face 54 as a face orthogonal to the radial direction, the secondary magnet opposing face 54 can be easily inscribed in the virtual circle C. In other words, according to the present embodiment, it is easy to form the secondary magnet opposing face 54 that is inscribed in the virtual circle C.

In the secondary magnet 50 according to the present embodiment, the first side face 51 and the second side face 52 are disposed in a wedge-like shape to be approaching each other as going toward the inner side in the radial direction (one side of the radial direction). Similarly, the main magnet side face 41 of the main magnet 40 in contact with the first side face 51 and the second support face 22b of the rotor core 22 in contact with the second side face 52 are disposed in a V-groove shape to be approaching each other as going toward the inner side in the radial direction (one side of the radial direction).

According to the present embodiment, by assembling the secondary magnet 50 between the main magnet side face 41 of the main magnet 40 and the second support face 22b of the rotor core 22 by inserting it from the outer side in the radial direction (the other side of the radial direction), the secondary magnet 50 and the main magnet 40 as well as the secondary magnet 50 and the rotor core 22 can be reliably brought into contact, regardless of the dimensional tolerance of the main magnet 40 and the secondary magnet 50 in the circumferential direction.

The secondary magnet 50 is provided to reduce magnetic resistance by configuring the shortest magnetic path between the main magnets 40 lined in the circumferential direction in the rotor 20. According to the present embodiment, by bringing the face (first side face 51) of the secondary magnet 50 on one side of the circumferential direction into contact with the main magnet 40, a magnetic path can pass directly between the secondary magnet 50 and the main magnet 40. Thus, compared to a case with a void, it is possible to suppress an increase in the magnetic resistance. Furthermore, by bringing the face (second side face 52) of the secondary magnet 50 on the other side of the circumferential direction into contact with the rotor core 22, a magnetic path can pass along the circumferential direction between the magnetic pole parts 28 adjacent to each other in the circumferential direction via the rotor core 22. This makes it possible to reduce the magnetic resistance between the secondary magnets 50 adjacent to each other in the circumferential direction. In other words, according to the present embodiment, the magnetic resistance of the magnetic path passing through the rotor 20 can be suppressed without extremely increasing the dimensional accuracy of the main magnet 40 and the secondary magnet 50. This makes it possible to strengthen the magnetic field formed on the outer side of the rotor 20 in the radial direction and configure the rotating electrical machine 1 with high output.

In the present embodiment, the inner end part of the secondary magnet 50 in the radial direction is disposed on the inner side in the radial direction with respect to the main magnet 40. Furthermore, part of the second side face 52 of the secondary magnet 50 is disposed on the inner side in the radial direction of the main magnet supported face 42 of the main magnet 40. Therefore, the part of the second support face 22b adjacent to the first support face 22a provided as the outer peripheral face of the rotor core 22 is recessed in a groove-like shape into the inner side in the radial direction with respect to the first support face 22a. According to the present embodiment, the recess on the outer peripheral face of the rotor core 22 can be used for positioning the secondary magnet 50, so that the assembly process of the rotor 20 can be simplified. Furthermore, according to the present embodiment, the secondary magnet 50 can be easily disposed by bringing it closer to the main magnet 40 in the circumferential direction, and a wide contact area can be secured between the first side face 51 and the main magnet side face 41. This makes it possible to further lower the magnetic resistance of the magnetic path passing through the rotor 20.

According to the present embodiment, the second side face 52 is a flat face that is orthogonal to the magnetization direction of the secondary magnet 50. As for the general magnets, a magnet mass-produced in advance (hereinafter, referred to as “material magnet 50A”) is used by being polished into a desired shape for each of products. The material magnet 50A before polishing is formed in a quadrangular prism shape. Furthermore, the material magnet 50A before polishing is magnetized in the direction orthogonal to the face direction of the quadrangular prism for ease of magnetization and the like. With the secondary magnet 50 according to the present embodiment, since the second side face 52 is orthogonal to the magnetization direction, part of the external shape of the material magnet 50A can be used as the second side face 52 in the manufacturing process of the secondary magnet 50.

FIG. 2 illustrates the shape of the material magnet 50A used in the manufacture of the secondary magnet 50 with a two-dot dashed line. According to the present embodiment, by using one face of the material magnet 50A as the second side face 52 of the secondary magnet 50, the portion to be removed from the material magnet 50A by machining can be reduced when manufacturing the secondary magnet 50. Thereby, out of the volume of the material magnet 50A, the volume of material that can be used as the secondary magnet 50 can be increased, so that the secondary magnet 50 with a desired magnetic force can be manufactured with less material. As a result, the secondary magnet 50 can be manufactured at a low cost.

In the secondary magnet 50 according to the present embodiment, the second side face 52 is a face derived from the face of the material magnet 50A. However, this effect can be achieved if at least some of the side faces of the secondary magnet 50 extending in the axial direction are flat faces that are parallel or orthogonal to the magnetization direction.

On the other hand, the second side face 52 of the secondary magnet 50 contacts the second support face 22b of the rotor core 22, allowing the magnetic path to pass through. Therefore, out of the side faces of the secondary magnet 50 extending in the axial direction, the second side face 52 is a side face whose area is relatively wide. With the second side face 52 being the face orthogonal to the magnetization direction of the secondary magnet 50, the face (second side face 52) that needs to have a wide area can be the face derived from the face of the material magnet 50A. Thus, it is possible to effectively reduce the amount of removal when manufacturing the secondary magnet 50. As a result, it is possible to reduce the manufacturing cost of the secondary magnet 50.

In the secondary magnet 50 according to the present embodiment, a second dimension H2 in the face direction of the second side face 52 is larger than a first dimension H1 in the normal direction of the second side face 52 when viewed from the axial direction. As described above, the second side face 52 contacts the second support face 22b of the rotor core 22, allowing the magnetic path to pass through. Therefore, the second support face 22b can be secured wide by securing the large second dimension H2 in the plane direction of the second side face 52. This makes it possible to lower the magnetic resistance of the magnetic path passing through the rotor 20.

Furthermore, as described above, the magnetization direction of the secondary magnet 50 is orthogonal to the second support face 22b. The magnetic path passing through the rotor 20 extends along the magnetization direction of the secondary magnet 50 inside the secondary magnet 50. According to the present embodiment, in the secondary magnet 50, the first dimension H1 that is along the magnetization direction is smaller, and the second dimension H2 that is orthogonal to the magnetization direction is larger. Thus, as for the magnetic path passing through the rotor 20, it is possible to shorten the magnetic path length and widen the cross-sectional area where the magnetic path passes inside the secondary magnet 50. Thus, it is possible to effectively lower the magnetic resistance.

In the present embodiment, the magnetization direction of the secondary magnet 50 is within the range of 45°±5° with respect to the radial direction. In other words, according to the present embodiment, the magnetization direction of the main magnet 40 is the radial direction, and the magnetization direction of the secondary magnet 50 disposed on the outer side of the main magnet 40 in the circumferential direction is within the range of 45°±5°. This makes it possible to effectively strengthen the magnetic field formed on the outer side in the radial direction by the magnetic pole part 28 that is configured with the main magnet 40 and a pair of secondary magnets 50, thereby making it possible to achieve higher output of the rotating electrical machine 1.

### Modification Example

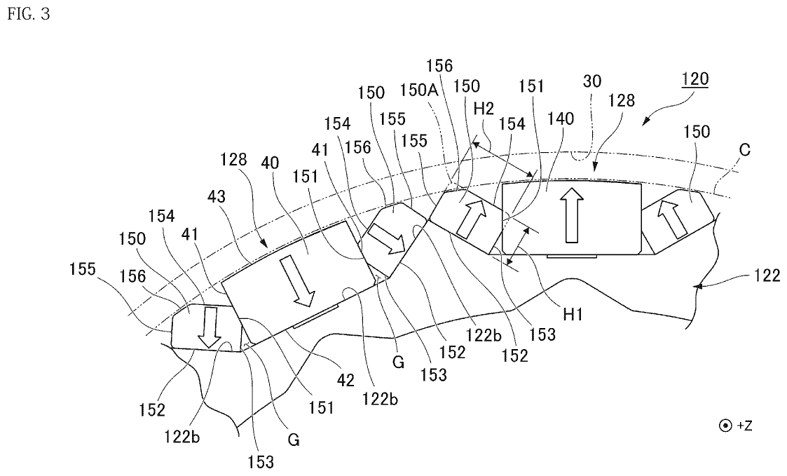

Next, a rotor 120 of a modification example that can be employed in the rotating electrical machine 1 of the above embodiment will be described with reference to FIG. 3. The rotor 120 of the modification example differs mainly in the shape of a secondary magnet 150 and the shape of a rotor core 122.

Note that the same reference signs are applied to the structural components same as those of the embodiment described above, and explanation thereof is omitted. The main magnet 40 of the modification example has the same configuration as that of the embodiment described above.

As in the embodiment described above, the rotor 120 of the present modification example includes a plurality of magnetic pole parts 128 lined along the circumferential direction centered on the central axis line J, and the rotor core 122 that supports the magnetic pole parts 128 from the inner side in the radial direction. One magnetic pole part 128 includes one main magnet 40 and two secondary magnets 150 disposed symmetrically with each other on the outer side of the main magnet 40 in the circumferential direction. The magnetization direction of the main magnet 40 is the radial direction. On the other hand, the magnetization direction of the secondary magnet 150 is a direction that is tilted in the circumferential direction with respect to the radial direction. The main magnets 40 and the secondary magnets 150 configuring each of the magnetic pole parts 128 are lined in the Halbach array.

The secondary magnet 150 is in a hexagonal shape when viewed from the axial direction. The secondary magnet 150 has six side faces 151, 152, 153, 154, 155, and 156 extending along the axial direction. That is, the secondary magnet 150 has a first side face 151, a second side face 152, a third side face 153, a fourth side face 154, a fifth side face 155, and a secondary magnet opposing face 156. The six side faces 151, 152, 153, 154, 155, and 156 of the secondary magnet 150 are all flat faces.

The first side face 151 is a flat face extending along the radial direction. The first side face 151 faces toward the circumferential direction. The first side face 151 opposes and contacts the main magnet side face 41 in the circumferential direction. That is, the secondary magnet 150 contacts the main magnet 40 at the first side face 151.

The second side face 152 is a flat face that faces toward the circumferential direction and the radial direction. The second side face 152 faces the opposite side of the first side face 151 in the circumferential direction. That is, the second side face 152 faces the outer side in the radial direction with respect to the main magnet 40. Furthermore, the second side face 152 faces the rotor core 122 side in the radial direction (that is, inner side in the radial direction). The second side face 152 is tilted toward the outer side in the radial direction (toward the other side of the radial direction) as going toward the outer side in the circumferential direction. The second side face 152 opposes and contacts the rotor core 122, thereby being supported. The rotor core 122 has a second support face (support face) 122b that supports the second side face 152.

The third side face 153 connects the first side face 151 and the second side face 152 when viewed from the axial direction. That is, the third side face 153 is disposed between the first side face 151 and the second side face 152 when viewed from the axial direction. The third side face 153 is orthogonal to the second side face 152. A gap G is provided between the third side face 153 and the main magnet side face 41. In other words, the third side face 153 and the main magnet 40 oppose each other via the gap G.

The fourth side face 154 faces the outer side in the radial direction. The fourth side face 154 connects the first side face 151 and the secondary magnet opposing face 156 when viewed from the axial direction. In other words, the fourth side face 154 is disposed between the first side face 151 and the secondary magnet opposing face 156 when viewed from the axial direction. The fourth side face 154 is a face parallel to the second side face 152.

The fifth side face 155 faces the opposite side of the first side face 151 in the circumferential direction. That is, the fifth side face 155 faces the outer side in the circumferential direction with respect to the main magnet 40. The fifth side face 155 extends along the radial direction. The fifth side face 155 is orthogonal to the second side face 152. Furthermore, the fifth side face 155 is a face parallel to the third side face 153.

The secondary magnet opposing face 156 faces the outer side in the radial direction (the other side of the radial direction). The secondary magnet opposing face 156 opposes the stator 30. The secondary magnet opposing face 156 is a flat face extending along a plane that is orthogonal to the radial direction. The secondary magnet opposing face 156 is inscribed in the virtual circle C. In other words, in the present modification example, the main magnet opposing face 43 and the secondary magnet opposing face 156 are inscribed in the common virtual circle C. The secondary magnet opposing face 156 is a flat face that is orthogonal to the radial direction. With the secondary magnet opposing face 156 being a flat face, the secondary magnet opposing face 156 can be formed by surface grinding when forming the shape of the secondary magnet 150, which makes it easier to improve the dimensional accuracy of the secondary magnet opposing face 156. Furthermore, by forming the secondary magnet opposing face 156 as a face orthogonal to the radial direction, the secondary magnet opposing face 156 can be easily inscribed in the virtual circle C. In other words, according to the present modification example, it is easy to form the secondary magnet opposing face 156 that is inscribed in the virtual circle C.

While the virtual circle C is illustrated in FIG. 3 by being slightly separated from the main magnets 40 and the secondary magnets 150 for clarity, the magnets are actually inscribed.

In the secondary magnet 150 according to the present modification example, the first side face 151 and the second side face 152 are disposed in a wedge-like shape to be approaching each other as going toward the inner side in the radial direction (one side of the radial direction). Therefore, by assembling the secondary magnet 150 between the main magnet side face 41 of the main magnet 40 and the second support face 122b of the rotor core 122 by inserting it from the outer side in the radial direction (the other side of the radial direction), the secondary magnet 150 and the main magnet 40 as well as the secondary magnet 150 and the rotor core 122 can be reliably brought into contact, regardless of the dimensional tolerance of the main magnet 40 and the secondary magnet 150 in the circumferential direction.

In the present modification example, the second side face 152 is a flat face that is orthogonal to the magnetization direction of the secondary magnet 150. In other words, the second side face 152 is orthogonal to the magnetization direction of the secondary magnet 150. The fourth side face 154 that is parallel to the second side face 152 is also orthogonal to the magnetization direction of the secondary magnet 150. Furthermore, the third side face 153 and the fifth side face 155 orthogonal to the second side face 152 are faces parallel to the magnetization direction of the secondary magnet 150. According to the secondary magnet 150 of the present modification example, since the second side face 152, the third side face 153, the fourth side face 154, and the fifth side face 155 are flat faces that are parallel or orthogonal to the magnetization direction, those faces can be used in the original magnet shape in the manufacturing process of the secondary magnet 150. This makes it possible to reduce the manufacturing cost of the secondary magnet 150.

FIG. 3 illustrates the shape of a material magnet 150A used in the manufacture of the secondary magnet 150 with a two-dot dashed line. According to the present modification example, by using four faces of the material magnet 150A as the second side face 152, the third side face 153, the fourth side face 154, and the fifth side face 155 of the secondary magnet 150, the portion to be removed from the material magnet 150A by machining can be reduced when manufacturing the secondary magnet 150. Thereby, out of the volume of the material magnet 150A, the volume of material that can be used as the secondary magnet 150 can be increased, so that the secondary magnet 150 with a desired magnetic force can be manufactured with less material. As a result, the secondary magnet 150 can be manufactured at a low cost.

As in the embodiment described above, in the secondary magnet 150 according to the present modification example, a second dimension H2 in the face direction of the second side face 152 is larger than a first dimension H1 in the normal direction of the second side face 152 when viewed from the axial direction. This makes it possible to lower the magnetic resistance of the magnetic path passing through the rotor 120, as in the embodiment described above.

The magnetization direction of the secondary magnet 150 is within the range of 45°±5° with respect to the radial direction, as in the embodiment described above. Thereby, as in the embodiment described above, it is possible to effectively strengthen the magnetic field formed on the outer side in the radial direction by the magnetic pole part 128 that is configured with the main magnet 40 and a pair of secondary magnets 150, thereby making it to possible to achieve higher output of the rotating electrical machine 1.

While the embodiment of the present invention and the modification example thereof are described above, each of the configurations of the embodiment and the modification example, combinations thereof, and the like are examples, and additions, omissions, substitutions, and other changes in the configurations are possible without departing from the scope of the present invention. Furthermore, the present invention is not limited by the embodiment and the modification example thereof.

For example, the shapes of the magnets and each of the shapes of the outer cores are not limited to the examples described in the aforementioned embodiment and modification example. Furthermore, the number of poles in the rotor and the number of slots in the stator are not limited to those described in the embodiment above.

The embodiment and the modification example thereof are described above by referring to a case of applying the present invention to a surface permanent magnet (SPM) rotor. However, the present invention may also be applied to an interior permanent magnet (IPM) rotor.

The rotating electrical machine to which the present invention is applied is not limited to a motor, and may also be a generator. The applications of the rotating electrical machine are not specifically limited. Furthermore, the postures when the rotating electrical machine is used are not specifically limited.

### REFERENCE SIGNS LIST

1 Rotating electrical machine
20, 120 Rotor
22, 122 Rotor core
22a First support face
22b, 122b Second support face (support face)
28, 128 Magnetic pole part
30 Stator
40 Main magnet
41 Main magnet side face
41, 51, 151 Side face
42 Main magnet supported face
43 Main magnet opposing face
50, 150 Secondary magnet
151 First side face
52, 152 Second side face
153 Third side face
54, 156 Secondary magnet opposing face
154 Fourth side face
155 Fifth side face
C Virtual circle
G Gap
H1 First dimension
H2 Second dimension
J Central axis line

1. A rotor that is provided to a rotating electrical machine, opposes a stator, and rotates about a central axis line, the rotor comprising:
a plurality of magnetic pole parts lined along a circumferential direction centered on the central axis line; and
a rotor core that supports the magnetic pole parts from one side of a radial direction, wherein
the magnetic pole part includes:
a main magnet whose magnetization direction is the radial direction; and
secondary magnets whose magnetization directions are directions tilted in a circumferential direction with respect to the radial direction, the secondary magnets being disposed symmetrically with each other on an outer side of the main magnet in the circumferential direction,
the main magnet has:
a main magnet supported face that faces one side of the radial direction; and
a pair of main magnet side faces that face an outer side in the circumferential direction,
the secondary magnet has:
a first side face that opposes and contacts the main magnet side face in the circumferential direction; and
a second side face that faces an opposite side of the first side face in the circumferential direction,
the first side face and the second side face approach each other as going toward the one side of the radial direction, and
the rotor core has:
a first support face that supports the main magnet supported face; and
a second support face that supports the second side face.

2. The rotor according to claim 1, wherein part of the second side face is disposed on the one side of the main magnet supported face in the radial direction.

3. The rotor according to claim 1 or 2, wherein, when viewed from the axial direction, in the secondary magnet, a second dimension in a face direction of the second side face is larger than a first dimension in a normal direction of the second side face.

4. The rotor according to any one of claims 1 to 3, wherein the second side face is a flat face that is orthogonal to the magnetization direction of the secondary magnet.

5. The rotor according to any one of claims 1 to 4, wherein the magnetization direction of the secondary magnet is within a range of 45°±5° with respect to the radial direction.

6. The rotor according to any one of claims 1 to 5, wherein
the main magnet has a main magnet opposing face that faces another side of the radial direction and opposes the stator,
the secondary magnet has a secondary magnet opposing face that faces the other side of the radial direction and opposes the stator, and
both the main magnet opposing face and the secondary magnet opposing face are inscribed in a virtual circle centered on the central axis line.

7. The rotor according to claim 6, wherein
the main magnet opposing face is an arc face whose curvature of radius is smaller than a radius of the virtual circle, and
the secondary magnet opposing face is a flat face that extends along a plane orthogonal to the radial direction.

8. A rotating electrical machine comprising:
the rotor according to any one of claims 1 to 7; and
the stator that opposes the rotor.
